(19) United States
(12) Patent Application Publication
(10) Pub. No.: US 2021/0289475 A1
(43) Pub. Date: Sep. 16, 2021

(54) RESOURCE ASSIGNMENT AND PACKET COLLISION AVOIDANCE IN SIDELINK COMMUNICATIONS

(71) Applicant: QUALCOMM Incorporated, San Diego, CA (US)

(72) Inventors: Vamshidhar Reddy S REDDY, Hyderabad (IN); Pradeep Kumar DARISI, Hyderabad (IN); Dileep Kumar VAYILAPELLI, Hyderabad (IN)

(21) Appl. No.: 17/019,720

(22) Filed: Sep. 14, 2020

(30) Foreign Application Priority Data
Mar. 13, 2020 (IN) 202041010838

(51) Int. Cl. H04W 72/02; H04W 72/00; H04W 72/12; H04W 4/40; H04L 5/00

(52) U.S. Cl. CPC H04W 72/02; H04W 72/005; H04W 92/18; H04W 4/40; H04L 5/0037; H04W 72/1257

(57) ABSTRACT

Certain aspects of the present disclosure provide techniques for resource block assignment and packet collision avoidance in sidelink communications. A method that may be performed by a first user equipment (UE) generally includes determining at least a first set of resources for a second UE overlaps at least a second set of resources for a third UE. The method generally includes broadcasting an indication of overlapping resources to at least the second UE and the third UE.

### CROSS-REFERENCE TO RELATED APPLICATION(S)

This application claims benefit of and priority to Indian Provisional Application No. 202041010838, filed Mar. 13, 2020, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for assigning resources to avoid packet collisions in sidelink direct communications.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved resource block assignment and reduced loss of communication.

Certain aspects of the subject matter described in this disclosure can be implemented in a method for wireless communication by a first user equipment (UE). The method generally includes determining at least a first set of resources for a second UE overlaps at least a second set of resources for a third UE. The method generally includes broadcasting an indication of the overlapping resources to at least the second UE and the third UE.

Certain aspects of the subject matter described in this disclosure can be implemented in a method for wireless communication by a first UE. The method generally includes determining a first set of resources allocated for transmission by the first UE. The method generally includes receiving a broadcast from at least a second UE of an indication of one or more resources of the first set of resources overlapping one or more resources of at least a second set of resources allocated for transmission by at least a third UE. The method generally includes, in response to the indication: stopping transmission on at least the one or more overlapping resources and determining a third set of resources allocated for transmission by the first UE, the third set of resources excluding the one or more overlapping resources.

Aspects of the disclosure can be implemented in an apparatus for wireless communication. The apparatus generally includes means for determining a first set of resources for a first UE overlaps a second set of resources for a second UE. The apparatus generally includes means for broadcasting an indication of the overlapping resources to the first UE and the second UE.

Aspects of the present disclosure can be implemented in an apparatus for wireless communication. The apparatus generally includes means for determining a first set of resources allocated for transmission by the apparatus. The apparatus generally includes means for receiving a broadcast from a first UE of an indication of one or more resources of the first set of resources overlapping one or more resources of a second set of resources allocated for transmission by a second UE. The apparatus generally includes means for, in response to the indication, stopping transmission on at least the one or more overlapping resources. The apparatus generally includes means for, in response to the indication, determining a third set of resources allocated for transmission by the apparatus, the third set of resources excluding the one or more overlapping resources.

Aspects of the disclosure can be implemented in a computer readable medium storing computer executable code thereon for wireless communication. The computer readable medium generally includes code for determining a first set of resources for a first UE overlaps a second set of resources for a second UE. The computer readable medium generally includes code for broadcasting an indication of the overlapping resources to the first UE and the second UE.

Aspects of the present disclosure can be implemented in a computer readable medium storing computer executable code thereon for wireless communication. The computer readable medium generally includes code for determining a first set of resources allocated for transmission by a first UE. The computer readable medium generally includes code for receiving a broadcast from a first UE of an indication of one or more resources of the first set of resources overlapping one or more resources of a second set of resources allocated for transmission by a second UE. The computer readable medium generally includes code for, in response to the indication, stopping transmission on at least the one or more overlapping resources. The computer readable medium generally includes code for, in response to the indication, determining a third set of resources allocated for transmission by the first UE, the third set of resources excluding the one or more overlapping resources.

Aspects of the disclosure can be implemented in an apparatus for wireless communication. The apparatus generally includes at least one processor configured to determine a first set of resources for a first UE overlaps a second set of resources for a second UE. The at least one processor is configured to broadcast an indication of the overlapping resources to the first UE and the second UE. The apparatus generally includes a memory coupled with the at least one processor.

Aspects of the present disclosure can be implemented in an apparatus for wireless communication. The apparatus generally includes at least one processor configured to determine a first set of resources allocated for transmission by the apparatus. The at least one processor is configured to receive a broadcast from a first UE of an indication of one or more resources of the first set of resources overlapping one or more resources of a second set of resources allocated for transmission by a second UE. The at least one processor is configured to in response to the indication, stop transmission on at least the one or more overlapping resources. The at least one processor is configured to in response to the indication, determine a third set of resources allocated for transmission by the apparatus, the third set of resources excluding the one or more overlapping resources. The apparatus generally includes a memory coupled with the at least one processor.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIGS. 5A, 5B, 5C, and 5D show an example hidden UE scenario, in accordance with certain aspects of the present disclosure.

FIG. 6 is a flow diagram illustrating example operations for wireless communication by a first UE, in accordance with certain aspects of the present disclosure.

FIG. 7 is a flow diagram illustrating example operations for wireless communication by a first UE, in accordance with certain aspects of the present disclosure.

FIG. 8 is a call flow diagram illustrating example signaling for assigning resource blocks in cellular V2X (C-V2X) direct communications, in accordance with certain aspects of the present disclosure.

FIG. 9 illustrates example resources when assigning resource blocks in C-V2X direct communications to avoid packet collision, in accordance with certain aspects of the present disclosure.

FIG. 10 illustrates a communications device that may include various components configured to perform operations for the techniques disclosed herein in accordance with aspects of the present disclosure.

FIG. 11 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for assigning resource blocks to avoid packet collision in sidelink communications, such as cellular vehicle-to-anything (C-V₂X) direct communications.

In C-V₂X systems, user equipment (UE), such as vehicular UEs, may directly communicate with each other using time-frequency resources autonomously selected by the UE. However, the autonomous selection of resources may cause problems when two UEs select the same resources, thereby causing packet collisions. For example, in some scenarios, a UE may be “hidden” (e.g., out of range of detection from another UE) during channel sensing and an initial resource selection (e.g., a semi-persistent scheduling (SPS) resource selection), but may move into an area with overlapping coverage after the resource selection. In this case, because the UEs are unaware of each other, the UEs may select interfering resources.

Accordingly, to avoid packet collisions, aspects of the present disclosure provide techniques for assigning resources to avoid packet collisions. In some examples, a victim UE may detect and broadcast overlapping resources. The UEs using the overlapping resources (e.g., the interfering or “aggressor” UEs) may receive the broadcast, stop transmitting on the overlapping resources, and perform another resource selection excluding the overlapping resources.

The following description provides examples of assigning resources to avoid packet collisions in sidelink communications, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

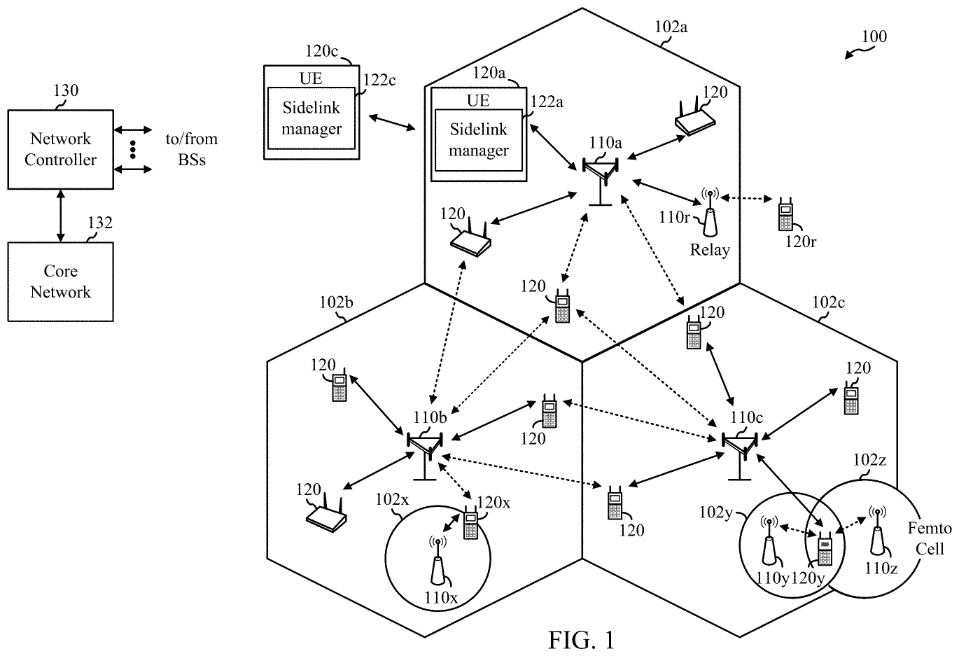

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the UEs 120 may be configured for assigning resource blocks (RBs) to avoid packet collision. As shown in FIG. 1, the UE 120a and UE 120c include a sidelink manager 122a and a sidelink manager 122c, respectively, that may be configured for resource assignment to avoid packet collisions in sidelink communications, in accordance with aspects of the present disclosure.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

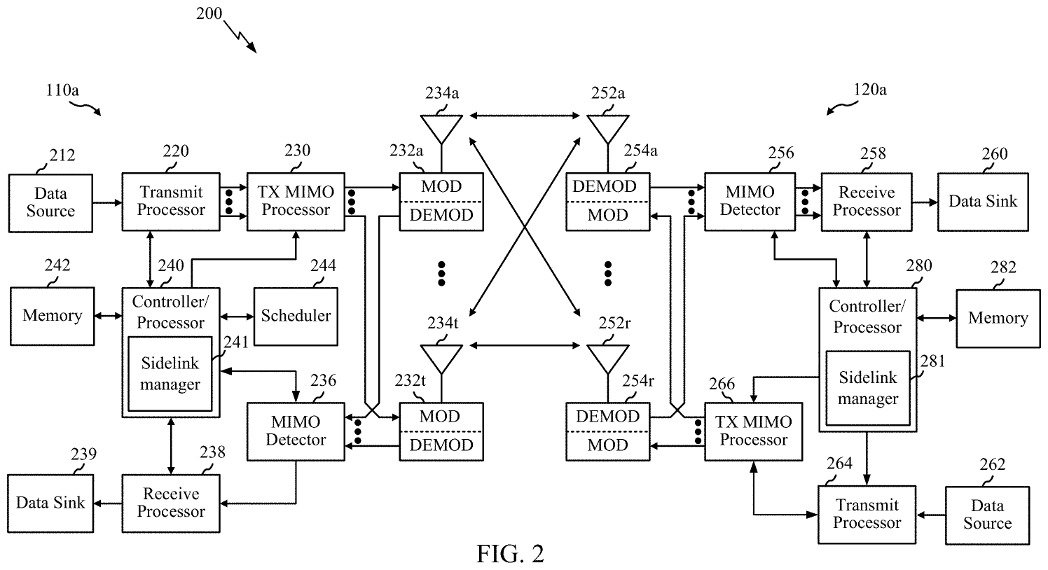

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a, the antennas 252a-252r may receive the downlink signals from the BS 110a or sidelink signals from a sidelink UE (e.g., such as the UE 120c) and may provide received signals to the demodulators (DEMODs) in transceivers 254a-254r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink or sidelink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a (or the sidelink UE 120c). At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a may be used to perform the various techniques and methods described herein. As shown in FIG. 2, the controller/processor 280 of the UE 120a has a sidelink manager 281 that may be configured for resource assignment to avoid packet collisions in sidelink communications, according to aspects described herein. Although shown at the controller/processor, other components of the UE 120a may be used to perform the operations described herein. The controller/processor 240 of the BS 110a also has a sidelink manager 241.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

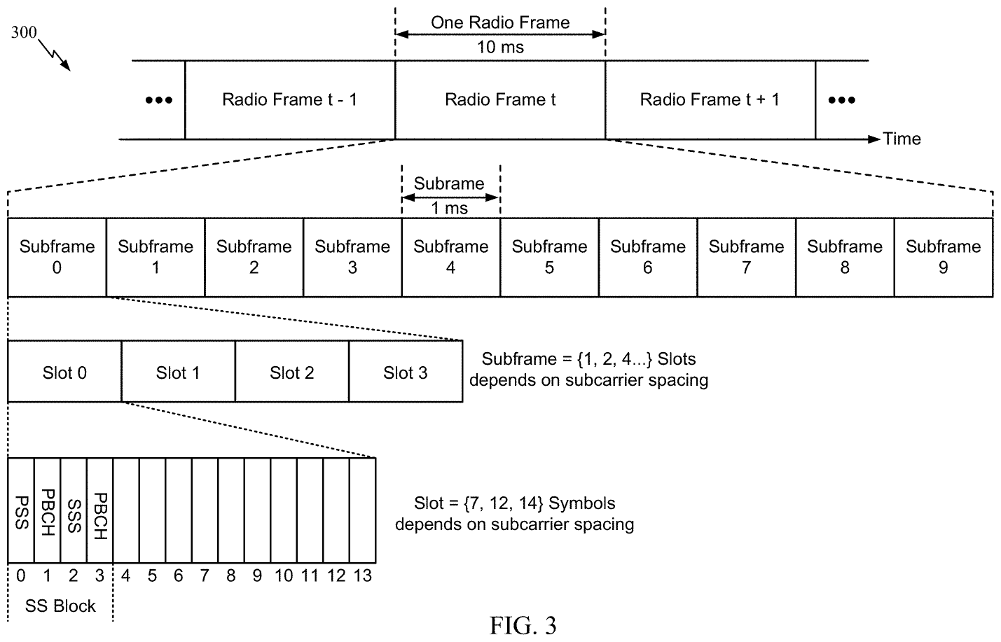

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

In some examples, the communication between the UEs 120 and BSs 110 is referred to as the access link. The access link may be provided via a Uu interface. Communication between devices may be referred as the sidelink.

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE 120a) to another subordinate entity (e.g., another UE 120) without relaying that communication through the scheduling entity (e.g., UE 120 or BS 110), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as CSI related to a sidelink channel quality.

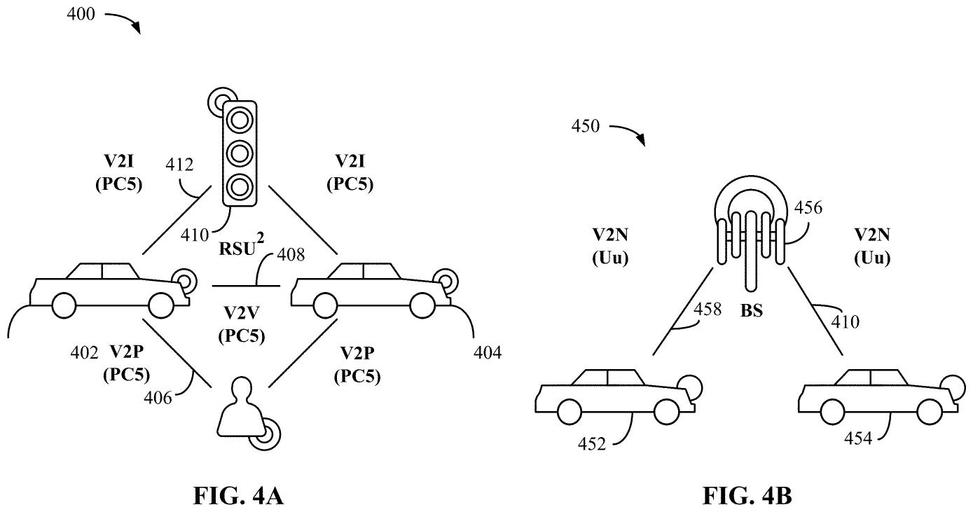

FIG. 4A and FIG. 4B show diagrammatic representations of example V₂X systems, in accordance with some aspects of the present disclosure. For example, the vehicles shown in FIG. 4A and FIG. 4B may communicate via sidelink channels and may perform sidelink CSI reporting as described herein.

The V₂X systems, provided in FIG. 4A and FIG. 4B provide two complementary transmission modes. A first transmission mode (also referred to as mode 4), shown by way of example in FIG. 4A, involves direct communications (for example, also referred to as side link communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V₂X system 400 (for example, including vehicle to vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V₂X system 400 may be a self-managed system implemented without assistance from a network entity. A self-managed system may enable improved spectral efficiency, reduced cost, and increased reliability as network service interruptions do not occur during handover operations for moving vehicles. The V₂X system may be configured to operate in a licensed or unlicensed spectrum, thus any vehicle with an equipped system may access a common frequency and share information. Such harmonized/common spectrum operations allow for safe and reliable operation.

FIG. 4B shows a V₂X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 410 may be used, for example, for long range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NB-type RSUs have similar functionality as the Macro eNB/gNB. The Micro NB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

As mentioned above, aspects of the present disclosure relate to sidelink communications, which can include cellular V2X (C-V2X) communications. A C-V2X system may operate in various modes. In an example mode, referred to as Mode 3 (or sidelink transmission mode 3), in which when the UE is in an in-coverage area, the network may control allocation of resources for the sidelink UEs. In another example mode for V2X systems, referred to as Mode 4 (sidelink transmission mode 4), the sidelink UEs may autonomously select resources (e.g., resource blocks (RBs)) used for transmissions to communicate with each other, instead of the network. For example, resources may be assigned using semi-persistent scheduling (SPS). In some examples, the sidelink UEs can autonomously select resources based on a configured SPS algorithm. The SPS algorithm may be configured, hardcoded, or preconfigured at the UE. For example, the SPS algorithm may be based on an SPS algorithm defined in the 3GPP technical standards.

In some cases, a “hidden terminal” scenario may occur due to the dynamically changing environment. For example, when the sidelink UE (e.g., a vehicle) selects resources for transmissions (e.g., in the Mode 4), some other UEs (e.g., other vehicles) may be hidden (e.g., undetected), such as when a channel sensing is performed. Thus, two (or more) UEs may autonomously select the same resources. The two UEs may later move closer to each other into an overlapping coverage area and, thus, their packet transmissions may collide.

Hidden terminal scenarios (leading to packet collision) may occur when UEs have overlapping coverage area while assigning RBs for transmission. The hidden terminal scenario may also occur when two UEs are physically apart from each other while allocating RBs, but after some time the UEs move towards each other resulting in the hidden terminal scenario.

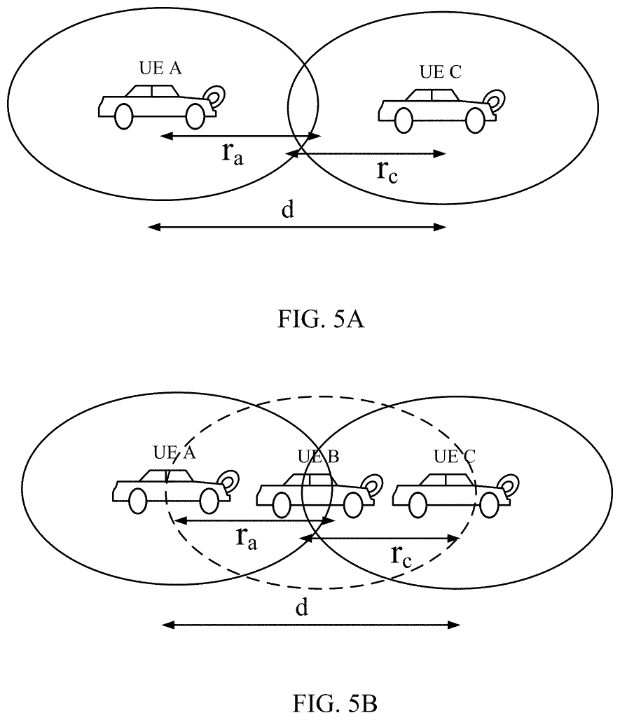

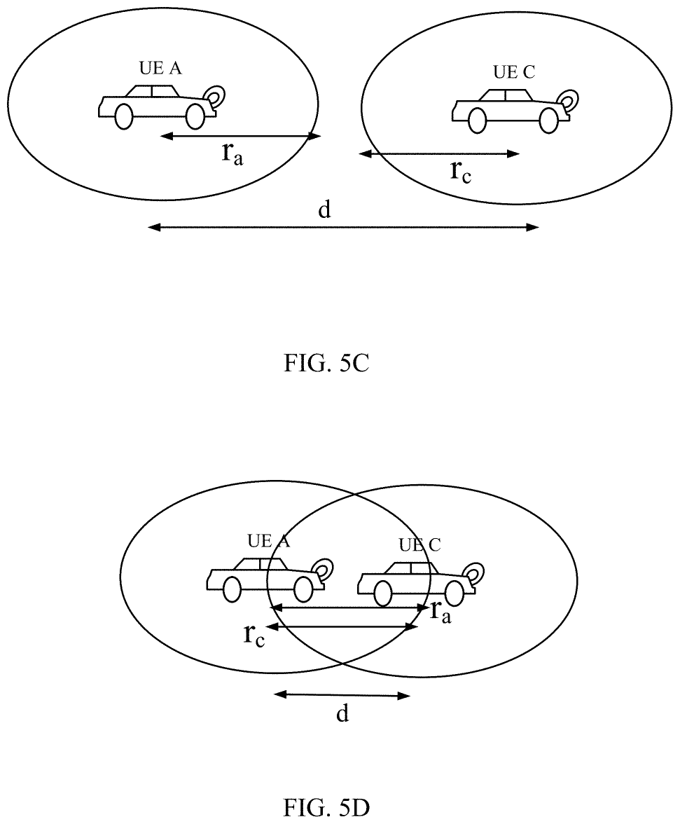

FIG. 5A illustrates a hidden terminal scenario. The UE A and UE C cannot sense each other's presence, for example, because these UEs are outside the coverage range of each other. For example, UE C is outside the coverage range of UE A rₐ and the UE A is outside the coverage range r_{c} of UE C. Thus, UE A and UE C are hidden from each other. As shown in FIG. 5A, the physical distance, d, between UE A and UE C is at least r_{A}+r_{C}, where r_{A} is the radius of UEs A's coverage and r_{C} is the radius of UE C's coverage. UE A does not know about the existence of UE C (the “hidden node”), and similarly, UE C does not know about the existence of UE A. Because UE A and UE C do not know about the other, both UEs may allocate/select the same time-frequency resources (some or all) (e.g., overlapping RBs) for transmission. In this case, UEs in the common area of UE A and UE C (A∩C), such as UE B shown in FIG. 5B) cannot decode the data transmitted from either UE A or UE C using the allocated resources, due to the packet collision.

Packet collision will continue to occur until one of the UE (either UE A or UE C) reschedules or allocates (e.g., reselects) new resources. However, even if one of the UEs reschedules or allocates new RBs for transmission, if the information about these new RBs may not be conveyed, and packet collision may still occur. Packet collisions may cause issues with the up-to-date information known to the UE. For example, because of packet collision, a UE in the common area of UE A and UE C (e.g., UE B) may not receive information regarding accidents and/or traffic, which may thereby cause further undesired consequences (e.g., accidents, traffic congestion).

In some cases, the packet collision may increase and/or decrease based on the relative speeds of UE A and UE C and density of UEs. For example, in a dense area, more hidden terminal scenarios may arise more often. Further, in a dense area, accidents and/or traffic congestion may be more likely to occur when packet collisions are occurring and the victim UE does not have access to up-to-date information. Further, when the relative speeds of UE A and UE C are similar, the hidden terminal scenario lasts for a longer duration than when the relative speeds are far apart.

Generally, the hidden terminal scenario does not occur when the UEs are outside of each other's coverage scenario or when the UEs are inside each other's coverage (and can therefore receive each other's allocation information).

FIG. 5C illustrates an example scenario where two UEs do not have overlapping coverage areas. As shown in FIG. 5C, the distance between the UE A and the UE C is greater than or equal to r_{A}+r_{C}. In this case, the packets may not collide.

FIG. 5D illustrates an example scenario where at least one of the two UEs is within the coverage range of the other UE. As shown in FIG. 5D, the distance, d, between the UE A and the UE C is less than at least one of r_{A} or r_{C}. In this case, the UEs may be able to receive each other resource assignments and, therefore, select resources that do not overlap. Thus, the UEs may not experience packet collision because of resource block assignment.

However, as mentioned above, in either of the examples shown in FIG. 5C and FIG. 5D, the UEs may later move into overlapping coverage (e.g., the distance between the UEs becomes less than r_{A}+r_{C} but greater than r_{A} or r_{C}), the hidden terminal scenario may arise.

Accordingly, what is needed are techniques and apparatus for avoiding packet collision in sidelink communications.

### Example Resource Assignment and Packet Collision Avoidance in Sidelink

Aspects of the present disclosure provide techniques to assign resources to avoid packet collision in sidelink communications. For example, aspects may help to mitigate packet collisions caused by the “hidden terminal” scenarios discussed above with respects to FIGS. 5A-D in certain systems, such as cellular vehicle-to-anything (C-V₂X) systems. In some examples, a victim user equipment (UE) may detect overlapping resources, such as common resource blocks (RBs), and indicate (e.g., by broadcasting) the overlapping resources to the other UEs. The other UEs (also referred to herein as “aggressor” or “hidden” UEs) may then receive the information from the victim UE and the aggressor UEs may stop transmission using the overlapping resources and reselect resources. For example, the aggressor UEs may exclude (e.g., remove from a list or set of available resources) the overlapping resources when selecting the new resources.

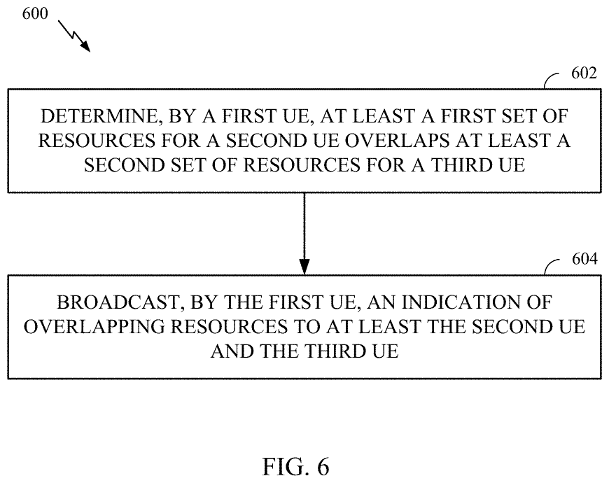

FIG. 6 is a flow diagram illustrating example operations 600 for wireless communication, in accordance with certain aspects of the present disclosure. The operations 600 may be performed, for example, by a first UE (e.g., the UE 120a in the wireless communication network 100, or UE B in FIG. 5B). The operations 600 may be implemented as software components that are executed and run on one or more processors (e.g., controller/processor 280 of FIG. 2). Further, the transmission and reception of signals by the UE in operations 600 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 600 may begin, at 602, by determining at least a first set of resources for a second UE overlaps at least a second set of resources for a third UE.

At 604, the UE broadcasts an indication of the overlapping resources to at least the second UE and the third UE.

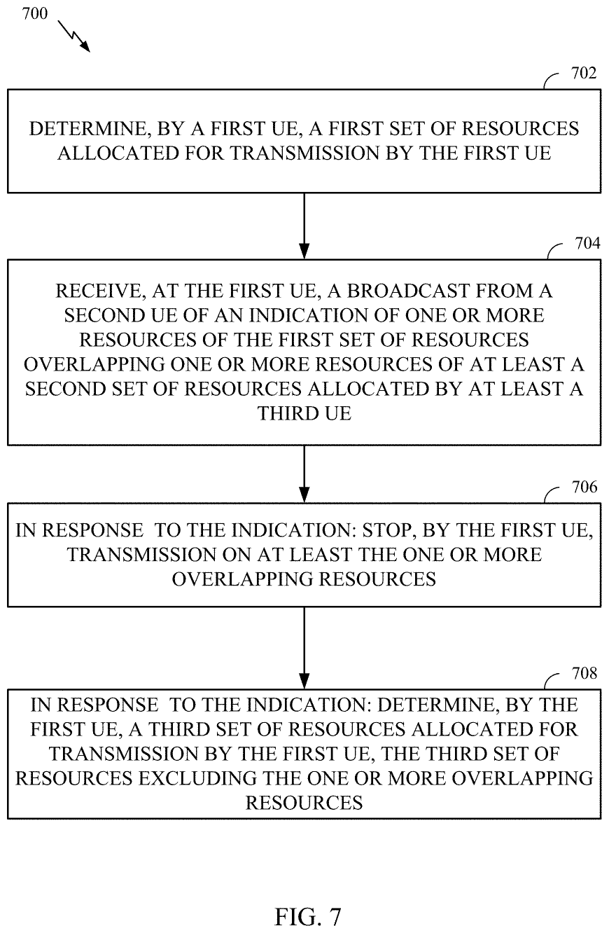

FIG. 7 is a flow diagram illustrating example operations 700 for wireless communication, in accordance with certain aspects of the present disclosure. The operations 700 may be performed, for example, by a first UE (e.g., the UE 120a in the wireless communication network 100, or UE A or UE C of FIG. 5B). The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 may begin, at 702, by determining a first set of resources allocated for transmission by the first UE.

At 704, the UE receives a broadcast from at least a second UE of an indication of one or more resources of the first set of resources overlapping one or more resources of at least a second set of resources allocated for transmission by at least a third UE.

At 706, in response to the indication, the UE stops transmission on at least the one or more overlapping resources.

At 708, in response to the indication, the UE determines a third set of resources allocated for transmission by the first UE, the third set of resources excluding the one or more overlapping resources.

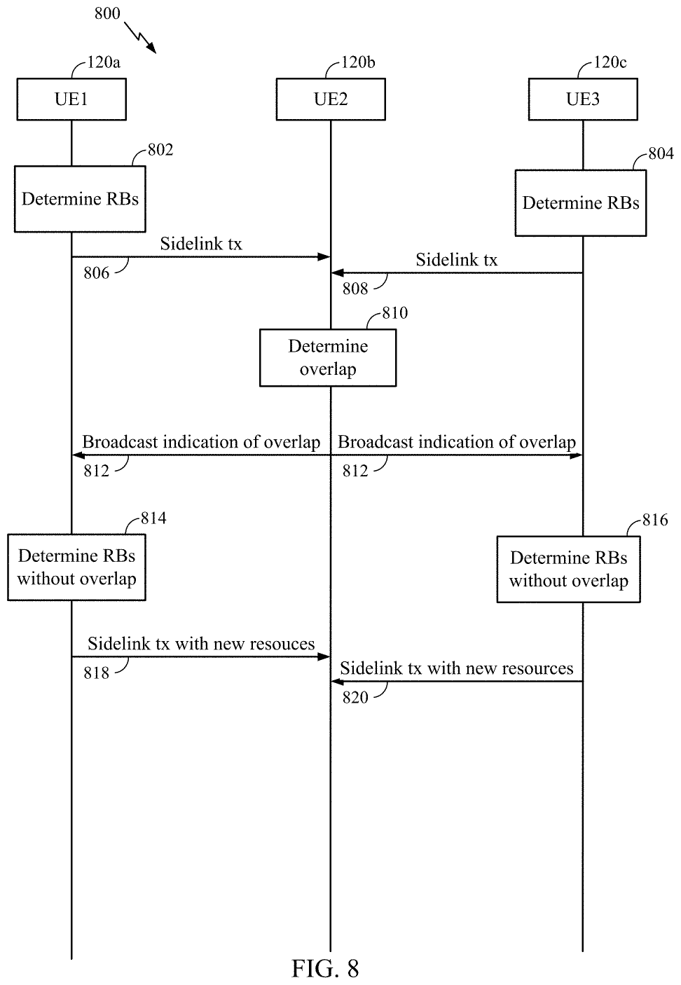

As illustrated in FIG. 8, at 802, the UE1 (e.g., the UE 120a, or UE A of FIG. 5B) determines a set of resources for communicating. At 804, the UE3 (e.g., the UE 120c, or UE C of FIG. 5B) determines a set of resources for communication. The determination may be based on a semi-persistent scheduling (SPS) resource assignment algorithm. The UE1 and the UE3, which may be the aggressor UEs, each send information about their determined set of resources and/or a transmission using the determined resources to the UE2 (e.g., the UE 120b, or UE B of FIG. 5B), which may be the victim UE, at 806 and 808, respectively (which may be concurrently). At 810, the UE2 determines whether the resources for UE1 overlaps with resources for UE3. At 812, the UE2 broadcasts an indication of overlapping resources to UE1 and UE3. In response to the indication from UE2, UE1 and UE3 stop transmitting on the overlapping resources and determine a new set of resources for transmission that excludes the overlapping resources at 814 and 816, respectively.

While some of the figures and examples in the present disclosure refer to three UEs (such as UE A, UE B, UE C), aspects of the present disclosure can apply to any number of UEs. For example, there can be multiple hidden terminals, multiple victim UEs, etc.

In certain aspects, the victim UE (e.g., UE2) broadcasts an indication of overlapping resources if it determines that resources from at least two UEs overlap. In some examples, aggressor UEs (e.g., UE1 and UE3) may allocate resources, for example, based on a SPS procedure (e.g., SPS allocated RBs). The aggressor UEs may choose RBs from a list of resources detected as free resources (e.g., based on control information and/or channel sensing). In some cases, the hidden vehicles may determine the resources via autonomously selecting the SPS allocated RBs according to a preconfigured SPS algorithm.

The UEs (aggressor UEs and/or victim UEs) may inform other UEs (either aggressor UEs and/or victim UEs) of their RB allocation by transmitting information of its RB allocation to other UEs. Transmission of resource allocation information may be sent in a physical sidelink control channel (PSCCH) transmissions and/or a physical sidelink shared channel (PSSCH) transmissions. In some cases, the victim UE monitors for transmissions from the aggressor UEs.

The victim UE may determine whether the resources of one aggressor UE (e.g., UE1) overlaps with the resources of another aggressor UE (e.g., UE3). If the victim UE determines that there are overlapping resources, the victim UE may send (e.g., broadcasts) an indication of the overlapping resources to the two aggressor UEs. In some cases, the victim UE may send (e.g., broadcasts) the indication via PSCCH transmissions or PSSCH transmissions.

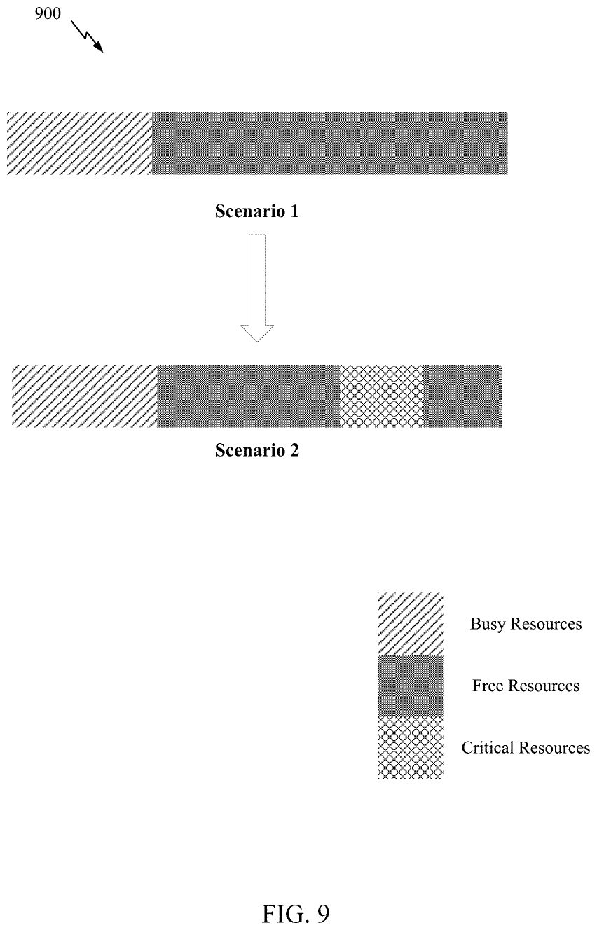

FIG. 9 illustrates example resources from which the aggressor UEs can select resources. FIG. 9 illustrates a set of resources 900 including resources detected as busy resources and resources detected as free and/or available resources. The aggressor UEs may select their resources from the resources detected as free. In an ideal scenario (Scenario 1), the resources detected as free and remain free. However, due to the hidden terminal scenario (Scenario 2), packet collision may occur when the aggressor UEs both select the same free resources (the critical resources in Scenario 2) for transmission. In order to remedy the hidden terminal scenario, the victim UE may transmit the indication of the overlapping (e.g., critical) resources.

In response to the indication, the aggressor UEs may stop transmitting on the resources (e.g., immediately) and may determine (e.g., re-determine, reselect) an allocation of RBs excluding the overlapping resources. In some cases, the aggressor UEs may repeat the SPS selection/assignment algorithm and remove the overlapping RBs from the assignable RB list (e.g., the available RBs) to avoid and/or reduce packet collision. In some cases, until the broadcasting vehicle broadcasts the indication of overlapping resources, the aggressor UEs may not detect that its allocated resources overlap with allocated resources of another vehicle.

In some cases, the aggressor UEs may transmit the RB allocation (e.g., the new and/or reselected resources) that excludes the overlapping resources to the victim UE. The victim UE may also monitor for transmissions using the resources excluding the overlapping resources from the hidden vehicles. Monitoring for transmissions using the resources may involve unsuccessfully decoding the transmissions from the hidden vehicles.

Advantages of aspects of the present disclosure, include but are not limited to, avoiding or reducing hidden vehicle instances, avoiding loss of communication and/or interference, and increasing utilization of the transmission spectrum by reducing the Packet Drop Rate (PDR). In some cases, aspects of the present disclosure help prevent loss of information due to the aggressor UEs being hidden. The information can include, but are not limited to, collision avoidance safety information, traffic signal timing, traffic signal priority, safety alerts to pedestrians and/or bicyclists, real-time traffic and/or routing, and cloud service information.

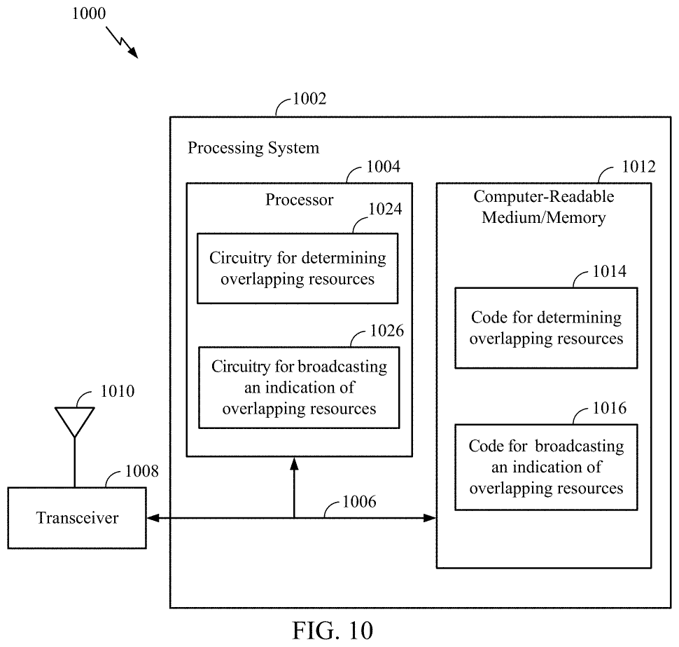

FIG. 10 illustrates a communications device 1000 that may include various components (e.g., corresponding to means-plus-function components) configured to perform operations for the techniques disclosed herein, such as the operations illustrated in FIG. 6. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 6, or other operations for performing the various techniques discussed herein for resource block assignment in C-V₂X direct communications. In certain aspects, computer-readable medium/memory 1012 stores code 1014 for determining at least a first set of resources for a second UE overlaps at least a second set of resources for a third UE; and code 1016 for broadcasting an indication of overlapping resources to at least the second UE and the third UE. In certain aspects, the processor 1004 has circuitry configured to implement the code stored in the computer-readable medium/memory 1012. The processor 1004 includes circuitry 1024 for determining at least a first set of resources for a second UE overlaps at least a second set of resources for a third UE; and circuitry 1026 for broadcasting an indication of overlapping resources to at least the second UE and the third UE.

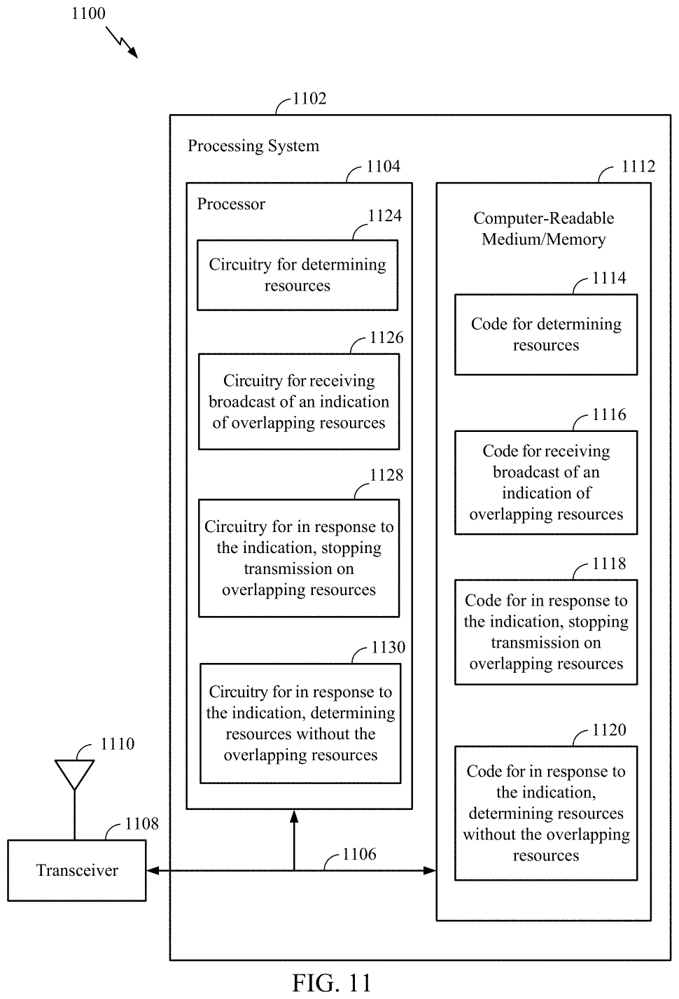

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7, or other operations for performing the various techniques discussed herein for resource block assignment in C-V₂X direct communications. In certain aspects, computer-readable medium/memory 1112 stores code 1114 for determining a first set of resources allocated for transmission by the first UE; code 1016 for receiving a broadcast from at least a second UE of an indication of one or more resources of the first set of resources overlapping one or more resources of at least a second set of resources allocated for transmission by at least a third UE; code 1118 for in response to the indication, stopping transmission on at least the one or more overlapping resources; and code 1120 for in response to the indication, determining a third set of resources allocated for transmission by the first UE, the third set of resources excluding the overlapping resources. In certain aspects, the processor 1104 has circuitry configured to implement the code stored in the computer-readable medium/memory 1112. The processor 1104 includes circuitry 1124 for determining a first set of resources allocated for transmission by the first UE; circuitry 1126 for receiving a broadcast from at least a second UE of an indication of one or more resources of the first set of resources overlapping one or more resources of at least a second set of resources allocated for transmission by at least a third UE; code 1128 for in response to the indication, stopping transmission on at least the one or more overlapping resources; and code 1130 for in response to the indication, determining a third set of resources allocated for transmission by the first UE, the third set of resources excluding the overlapping resources.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6 and/or FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a first user equipment (UE), comprising:
determining at least a first set of resources for a second UE overlaps at least a second set of resources for a third UE; and
broadcasting an indication of the overlapping resources to at least the second UE and the third UE.

2. The method of claim 1, wherein:
determining the at least a first set of resources for the second UE overlaps the at least a second set of resources for the third UE comprises determining overlap for a plurality of sets of resources for a plurality of UEs; and
broadcasting an indication of the overlapping resources to at least the second UE and the third UE comprises broadcasting the indication of the overlapping resources to the plurality of UEs.

3. The method of claim 1, wherein determining the first set of resources for the second UE overlaps the second set of resources for the third UE comprises:
receiving a first resource allocation information from the second UE indicating the first set of resources;
receiving a second resource allocation information from the third UE indicating the second set of resources; and
determining the overlap based on the first and second resource allocation information.

4. The method of claim 3, wherein receiving the first and second resource allocation information comprising receiving the first and second resource allocation information via one of one or more physical sidelink control channel (PSCCH) transmissions and one or more physical sidelink shared channel (PSSCH) transmissions.

5. The method of claim 3, wherein determining the first set of resources for the second UE overlaps the third set of resources for the third UE comprises:
monitoring transmission from the second UE using the first set of resources;
monitoring transmission from the third UE using the second set of resources; and
determining the overlap based on the monitoring.

6. The method of claim 5, further comprising:
unsuccessfully decoding the transmission from the second UE, the third UE, or both.

7. The method of claim 1, wherein the first and second sets of resources comprise semi-persistently scheduled (SPS) resource blocks (RBs).

8. The method of claim 1, wherein broadcasting the indication comprises broadcasting the indication via one of a physical sidelink control channel (PSCCH) transmissions and a physical sidelink shared channel (PSSCH).

9. The method of claim 1, further comprising:
in response to broadcasting the indication of the overlapping resources, receiving updated resource allocation information from each of the second UE and the third UE.

10. The method of claim 1, wherein the first UE, the second UE, and the third UE comprise vehicle-to-anything (V₂X) capable UEs.

11. The method of claim 1, wherein the first UE, the second UE, and the third UE are configured for sidelink transmission mode 4 vehicle-to-anything (V₂X) communications via a sidelink channel, and wherein the first UE, the second UE, and the third UE autonomously allocate resources for transmission.

12. A method for wireless communication by a first user equipment (UE), comprising:
determining a first set of resources allocated for transmission by the first UE;
receiving a broadcast from a second UE of an indication of one or more resources of the first set of resources overlapping one or more resources of a second set of resources allocated for transmission by a third UE; and
in response to the indication:
stopping transmission on at least the one or more overlapping resources; and
determining a third set of resources allocated for transmission by the first UE, the third set of resources excluding the one or more overlapping resources.

13. The method of claim 12, wherein receiving the broadcast from the at least the second UE of the indication comprises:
receiving broadcast from a plurality of UEs of an indication of one or more resources of the first set of resources overlapping one or more resources of a plurality of sets of resources for the plurality of UEs.

14. The method of claim 12, wherein determining the first set of resources, the second set of resources, or both, comprises:
determining semi-persistently scheduled (SPS) resource blocks (RBs).

15. The method of claim 14, wherein determining the SPS RBs comprises autonomously selecting the SPS RBs according to a preconfigured SPS algorithm.

16. The method of claim 12, further comprising:
transmitting resource allocation information to the second UE indicating the first set of resources, wherein the broadcast from the second UE is received in response to the resource allocation information.

17. The method of claim 16, wherein transmitting the resource allocation information comprises transmitting the resource allocation information via one of a physical sidelink control channel (PSCCH) transmission and a physical sidelink shared channel (PSSCH).

18. The method of claim 12, wherein receiving the broadcast of the indication comprises receiving the broadcast of the indication via one of a physical sidelink control channel (PSCCH) transmission and a physical sidelink shared channel (PSSCH).

19. The method of claim 12, wherein determining the first set of resources comprises:
detecting a set of available resources; and
selecting the one or more resources of the first set of resources from the set of available resources.

20. The method of claim 19, wherein determining the third set of resources comprises:
updating the set of available resources by removing the one or more overlapping resources from a set of available resources; and
selecting the third set of resources from the updated set of available resources.

21. The method of claim 12, wherein the first UE, the second UE, and the third UE comprise vehicle-to-anything (V₂X) capable UEs.

22. The method of claim 12, wherein the first UE, the second UE, and the third UE are configured for sidelink transmission mode 4 vehicle-to-anything (V2X) communications via a sidelink channel, and wherein the first UE, the second UE, and the third UE autonomously allocate resources for transmission.

23. An apparatus for wireless communication, comprising:
at least one processor configured to:
determine a first set of resources for a first user equipment (UE) overlaps a second set of resources for a second UE; and
broadcast an indication of the overlapping resources to the first UE and the second UE; and
a memory coupled with the at least one processor.

24. The apparatus of claim 23, wherein determining the at least a first set of resources for the first UE overlaps the at least a second set of resources for the second UE comprises means for determining overlap for a plurality of sets of resources for a plurality of UEs; and
broadcasting an indication of the overlapping resources to at least the first UE and the second UE comprises means for broadcasting the indication of the overlapping resources to the plurality of UEs.

25. The apparatus of claim 23, wherein determining the first set of resources for the first UE overlaps the second set of resources for the second UE comprises:
receiving a first resource allocation information from the first UE indicating the first set of resources;
receiving a second resource allocation information from the second UE indicating the second set of resources; and
determining the overlap based on the first and second resource allocation information.

26. The apparatus of claim 25, wherein determining the first set of resources for the first UE overlaps the second set of resources for the second UE comprises:
monitoring transmission from the first UE using the first set of resources;
monitoring transmission from the second UE using the second set of resources; and
determining the overlap based on the monitoring.

27. An apparatus for wireless communication, comprising:
at least one processor configured to:
determine a first set of resources allocated for transmission by the apparatus;
receive a broadcast from a first user equipment (UE) of an indication of one or more resources of the first set of resources overlapping one or more resources of a second set of resources allocated for transmission by a second UE; and
in response to the indication:
stop transmission on at least the one or more overlapping resources; and
determine a third set of resources allocated for transmission by the apparatus, the third set of resources excluding the one or more overlapping resources; and
a memory coupled with the at least one processor.

28. The apparatus of claim 27, wherein receiving the broadcast from the at least the second UE of the indication comprises:
receiving broadcast from a plurality of UEs of an indication of one or more resources of the first set of resources overlapping one or more resources of a plurality of sets of resources for the plurality of UEs.

29. The apparatus of claim 27, wherein the at least one processor is further configured to:
transmit resource allocation information to the second UE indicating the first set of resources, wherein the broadcast from the second UE is received in response to the resource allocation information.

30. The apparatus of claim 27, wherein determining the first set of resources comprises:
detecting a set of available resources; and
selecting the one or more resources of the first set of resources from the set of available resources.
